(19) United States
(12) Patent Application Publication
(10) Pub. No.: US 2026/0214330 A1
(43) Pub. Date: Jul. 23, 2026

(54) FOCUSING A CAMERA CAPTURING VIDEO DATA USING DIRECTIONAL DATA OF AUDIO

(71) Applicant: Telefonaktiebolaget LM Ericsson (publ), Stockholm (SE)

(72) Inventors: David LINDERO, LULEÅ (SE); Peter ÖKVIST, LULEÅ (SE); Tommy ARNGREN, SÖDRA SUNDERBYN (SE); Andreas KRISTENSSON, SANDBY (SE)

(73) Assignee: Telefonaktiebolaget LM Ericsson (publ), Stockholm (SE)

(21) Appl. No.: 19/139,535

(22) PCT Filed: Dec. 15, 2022
(86) PCT No.: PCT/EP2022/086033

§ 371 Date: Jun. 16, 2025

(51) Int. Cl. H04N 23/67; G10L 17/06; H04N 23/611; H04R 1/02; H04R 5/027; H04S 3/00

(52) U.S. Cl. CPC H04N 23/67; G10L 17/06; H04N 23/611; H04R 1/028; H04R 5/027; H04S 3/008; H04R 2499/11; H04S 2400/01; H04S 2400/15

(57) ABSTRACT

It is provided a method for focusing a camera capturing video data. The method is performed in a focus determiner. The method comprises: obtaining audio data and video data, comprising a plurality of sequential images, wherein the audio data and video data overlap in time and cover the same scene; determining directional data of a dominant sound source in the audio data; matching a visual feature spatially, in an image of the plurality of sequential images of the video data, with the directional data, wherein the image corresponds to the directional data in time; and focusing a camera, being the source of the video data, to focus on the visual feature for subsequent capturing of video data.

### TECHNICAL FIELD

The present disclosure relates to the field of cameras capturing video data and in particular to focusing a camera capturing video data.

### BACKGROUND

Cameras for video capture have been in use for a long time. In order to enable high-quality capture of the video, appropriate focusing of the camera needs to be applied.

Originally, only manual focus was available, where the camera person manually turns a focusing ring of the camera to adjust focus depending on what should be the main video object in the captured video. Autofocus options have become more common recently. Some camera devices, such as smartphones, perform contextual autofocus, identifying faces and focusing the image of the video on the face, at least if there is only one face.

A problem exists when there are multiple potential focus objects (e.g. faces), and in particular, how to determine focus when the potential focus objects are at different focal positions in relation to the camera.

### SUMMARY

One object is to improve how focusing is performed for a camera capturing video data.

According to a first aspect, it is provided a method for focusing a camera capturing video data. The method is performed in a focus determiner. The method comprises: obtaining audio data and video data, comprising a plurality of sequential images, wherein the audio data and video data overlap in time and cover the same scene; determining directional data of a dominant sound source in the audio data; matching a visual feature spatially, in an image of the plurality of sequential images of the video data, with the directional data, wherein the image corresponds to the directional data in time; and focusing a camera, being the source of the video data, to focus on the visual feature for subsequent capturing of video data.

The determining directional data may comprise determining a direction of the dominant sound source based on multiple sound channels in the audio data.

The matching a visual feature may comprise classifying a plurality of objects in the image being potential sound sources, and determining the visual feature to be the one of the plurality of objects that is located in a position that best matches the directional data.

The plurality of objects may be faces.

The method may further comprise: determining that a conversation occurs between a plurality of people associated with the faces, in which case the matching a visual feature comprises increasing a matching priority for sound sources matching directional data of the plurality of people associated with the faces.

The method may further comprise: adjusting a field of view such that the video data covers the dominant directional data of the dominant sound source.

The method may be repeated periodically with a time period corresponding to a preconfigured number of frames of the video data.

The camera may be provided in a user device, in which case the method further comprises: performing voice identification on the audio data, wherein the voice identification results in a match with a person. In this case, the matching a visual features comprises increasing a matching priority for a sound source matching directional data of the person, when the person is associated with the user of the user device, but fails to be the user.

The determining directional data of a dominant sound source may comprise excluding, as a potential dominant sound source, a sound source matching directional data of the person, when the voice data of the person is a matched with voice data of the user of the user device.

The method may further comprise: classifying a plurality of sound sources in the audio data; and determining for each classified sound source, whether the sound source is to be matched with a visual feature. In this case, the determining directional data of a dominant sound source comprises excluding, as a potential dominant sound source, any one or more sound sources that are determined not to be matched with a visual feature.

The method may further comprise: performing speech recognition of at least one voice sound source in the audio data, resulting in text data for each one of the at least one voice sound source. In this case, the matching a visual feature comprises adjusting a matching priority for each one of the at least one voice sound source based on the respective text data.

The camera and at least one microphone, for capturing the audio data, may be mounted in a fixed relation to each other.

According to a second aspect, it is provided a focus determiner for focusing a camera capturing video data. The focus determiner comprises: a processor; and a memory storing instructions that, when executed by the processor, cause the focus determiner to: obtain audio data and video data, comprising a plurality of sequential images, wherein the audio data and video data overlap in time and cover the same scene; determine directional data of a dominant sound source in the audio data; match a visual feature spatially, in an image of the plurality of sequential images of the video data, with the directional data, wherein the image corresponds to the directional data in time; and focus a camera, being the source of the video data, to focus on the visual feature for subsequent capturing of video data.

The instructions to determine directional data may comprise instructions that, when executed by the processor, cause the focus determiner to determine a direction of the dominant sound source based on multiple sound channels in the audio data.

The instructions to match a visual feature may comprise instructions that, when executed by the processor, cause the focus determiner to classify a plurality of objects in the image being potential sound sources, and determine the visual feature to be the one of the plurality of objects that is located in a position that best matches the directional data.

The plurality of objects may be faces.

The focus determiner may further comprise instructions that, when executed by the processor, cause the focus determiner to: determine that a conversation occurs between a plurality of people associated with the faces. In this case, the instructions to match a visual feature comprise instructions that, when executed by the processor, cause the focus determiner to increase a matching priority for sound sources matching directional data of the plurality of people associated with the faces.

The focus determiner may further comprise instructions that, when executed by the processor, cause the focus determiner to adjust a field of view such that the video data covers the dominant directional data of the dominant sound source.

The instructions may be repeated periodically with a time period corresponding to a preconfigured number of frames of the video data.

The camera may be provided in a user device, in which case the focus determiner further comprises instructions that, when executed by the processor, cause the focus determiner to perform voice identification on the audio data, wherein the voice identification results in a match with a person. In this case, the instructions to match a visual features comprise instructions that, when executed by the processor, cause the focus determiner to increasing a matching priority for a sound source matching directional data of the person, when the person is associated with the user of the user device, but fails to be the user.

The instructions to determine directional data of a dominant sound source may comprise instructions that, when executed by the processor, cause the focus determiner to exclude, as a potential dominant sound source, a sound source matching directional data of the person, when the voice data of the person is a matched with voice data of the user of the user device.

The focus determiner may further comprise instructions that, when executed by the processor, cause the focus determiner to: classify a plurality of sound sources in the audio data; and determine for each classified sound source, whether the sound source is to be matched with a visual feature. In this case, the instructions to determine directional data of a dominant sound source comprise instructions that, when executed by the processor, cause the focus determiner to exclude, as a potential dominant sound source, any one or more sound sources that are determined not to be matched with a visual feature.

The focus determiner may further comprise instructions that, when executed by the processor, cause the focus determiner to perform speech recognition of at least one voice sound source in the audio data, resulting in text data for each one of the at least one voice sound source. In this case, the instructions to match a visual feature comprise instructions that, when executed by the processor, cause the focus determiner to adjust a matching priority for each one of the at least one voice sound source based on the respective text data.

The camera and at least one microphone, for capturing the audio data, may be mounted in a fixed relation to each other.

According to a third aspect, it is provided a computer program for focusing a camera capturing video data. The computer program comprises computer program code which, when executed on a focus determiner causes the focus determiner to: obtain audio data and video data, comprising a plurality of sequential images, wherein the audio data and video data overlap in time and cover the same scene; determine directional data of a dominant sound source in the audio data; match a visual feature spatially, in an image of the plurality of sequential images of the video data, with the directional data, wherein the image corresponds to the directional data in time; and focus a camera, being the source of the video data, to focus on the visual feature for subsequent capturing of video data.

According to a fourth aspect, it is provided a computer program product comprising a computer program according to the third aspect and a computer readable means comprising non-transitory memory in which the computer program is stored.

Generally, all terms used in the claims are to be interpreted according to their ordinary meaning in the technical field, unless explicitly defined otherwise herein. All references to “a/an/the element, apparatus, component, means, step, etc.” are to be interpreted openly as referring to at least one instance of the element, apparatus, component, means, step, etc., unless explicitly stated otherwise. The steps of any method disclosed herein do not have to be performed in the exact order disclosed, unless explicitly stated.

### BRIEF DESCRIPTION OF THE DRAWINGS

Aspects and embodiments are now described, by way of example, with reference to the accompanying drawings, in which:

FIG. 1 is a schematic diagram illustrating an environment in which embodiments presented herein can be applied;

FIGS. 2A and 2B are schematic diagrams illustrating embodiments of where a focus determiner can be implemented.

FIGS. 3A and 3B are schematic diagrams illustrating how a conversation is tracked;

FIGS. 4A and 4B are schematic graphs illustrating how audio volume varies for different angles in the examples of FIGS. 3A-B, respectively;

FIGS. 5A and 5B are flow charts illustrating embodiments of methods for focusing a camera capturing video data;

FIG. 6 is a schematic diagram illustrating components of the focus determiner of FIGS. 2A and 2B according to one embodiment;

FIG. 7 is a schematic diagram showing functional modules of the focus determiner of FIG. 6 according to one embodiment; and

FIG. 8 shows one example of a computer program product comprising computer readable means.

### DETAILED DESCRIPTION

The aspects of the present disclosure will now be described more fully hereinafter with reference to the accompanying drawings, in which certain embodiments of the invention are shown. These aspects may, however, be embodied in many different forms and should not be construed as limiting; rather, these embodiments are provided by way of example so that this disclosure will be thorough and complete, and to fully convey the scope of all aspects of invention to those skilled in the art. Like numbers refer to like elements throughout the description.

According to embodiments presented herein, an improved solution for focusing a camera for capturing video data is provided. Specifically, directional data is obtained from audio data, to determine a dominant sound source. The object corresponding to the dominant sound source is then found, spatially, in an image of the video data and the camera is focused such that the dominant sound source is in focus. This results in a solution where the focus of the camera follows the dominant sound source, automatically switching focus when the dominant sound source switches. The user is thus relieved from the burden of constantly monitoring where to focus during the video capture. Optionally, sound sources that are considered to be irrelevant or of less interest are ignored.

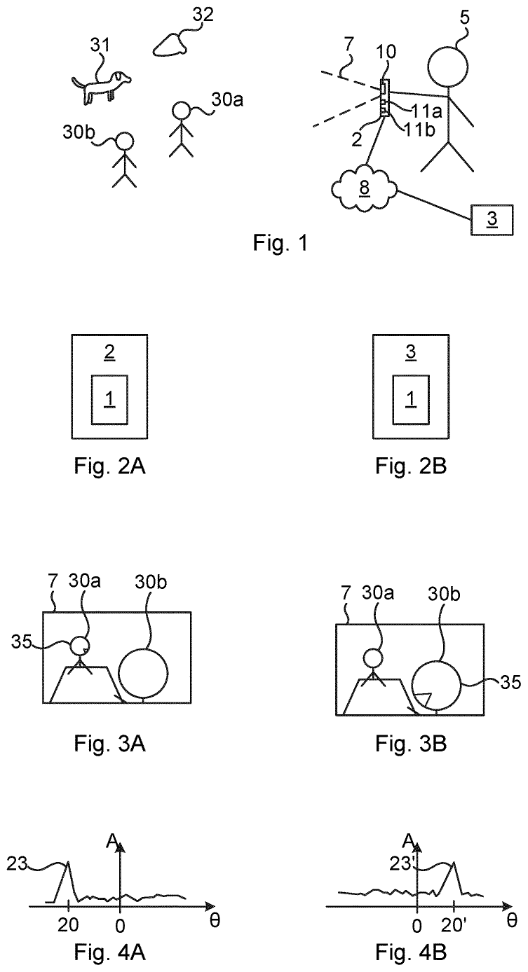

FIG. 1 is a schematic diagram illustrating an environment in which embodiments presented herein can be applied. A user 5 carries a user device 2. The user device 2 can be any suitable device for capturing media, e.g. a smartphone, mobile phone, wearable device, tablet computer, laptop computer, video camera etc. The user device 2 comprises a camera 10. The camera 10 is capable of capturing images and can be any suitable camera, e.g. a 2D camera, a stereoscopic 3D camera, etc. Alternatively or additionally, the camera comprises a lidar, radar, UWB (Ultra Wideband) sensor, etc. The camera is capable of capturing a plurality of sequential images as a video stream. The user device 2 also comprises one or more microphones 11a-b. The one or more microphones 11a, 11b are capable of detecting a direction from which sound is captured. For instance, this can be achieved by two microphones 11a-b providing two parallel sound channels, providing stereophonic sound capture.

The camera 10 has a certain field of view (FOV) 7 defining the spatial scope of its capturing. The FOV 7 can vary depending on zoom level and the direction in which the camera 10 is pointed. Optionally, the camera captures a larger FOV from which a FOV for recording is selected. This allows the FOV to be selected, e.g. by the user device 2, as a subset of a maximum available FOV.

There can be multiple visual features (objects) 30a, 30b, 31, 32 that can form part of the images captured by the camera 10. For instance, in this example, there are visual features in the form of two people 30a, 30b, a dog 31 and a rock 32.

The user device 2 can communicate with a server 3 over an Internet Protocol (IP)-based communication network 8, such as the Internet. The communication network 8 can be based on any combination of wireless and/or wire-based communication e.g. Ethernet, and/or wireless communication, such as Wi-Fi, and/or a cellular network, complying with any one or a combination of sixth generation (6G) mobile networks, next generation mobile networks (fifth generation, 5G), LTE (Long Term Evolution), UMTS (Universal Mobile Telecommunications System) utilising WCDMA (Wideband Code Division Multiplex), or any other current or future wireless network, as long as the principles described hereinafter are applicable.

The server 3 is also connected to the communication network 8. The server can be a so-called edge server, being provided topologically and/or geographically near the user device 2. Alternatively, the server 3 can be provided as a central server, also known as a cloud server.

FIGS. 2A and 2B are schematic diagrams illustrating embodiments of where a focus determiner 1 can be implemented.

In FIG. 2A, the focus determiner 1 is shown as implemented in the user device 2. The user device 2 is thus the host device for the focus determiner 1 in this implementation.

In FIG. 2B, the focus determiner 1 is shown as implemented in the server 3. The server 3 is thus the host device for the focus determiner 1 in this implementation.

FIGS. 3A and 3B are schematic diagrams illustrating how a conversation is tracked. A FOV 7 is shown, the inside of which is captured by the camera 10. There are here visual features 30a, 30b in the form of two people, a first person 30a and a second person 30b. The first person 30a and the second person 30b are engaged in a conversation. The first person 30a is further away from the camera 10 than the second person 30b, whereby the camera might not be able to keep both people 30a and 30b in focus at the same time. In FIG. 3A, an image is captured at a time when the first person 30a is talking. According to embodiments presented herein, the focus 35 of the camera 10 is then adjusted such that the first person 30a is in focus.

In FIG. 3B, an image is captured at a time when the second person 30b is talking. According to embodiments presented herein, the focus 35 of the camera 10 is then adjusted such that the second person 30b is in focus.

FIGS. 4A and 4B are schematic graphs illustrating how audio volume varies for different angles in the examples of FIGS. 3A and 3B, respectively. The vertical axis represents amplitude (A) of sound pressure, i.e. sound intensity, and the horizontal axis represents angle θ. The angle, with reference to FIGS. 3A and 3B, is 0 at the middle of the FOV 7, increases going to the right and decreases going to the left. The data corresponding to diagrams 4A and 4B is captured using a plurality of (e.g. two) microphones. The zero-point of the angle θ can be set at different points, as long as the captured audio data corresponds to the scene in the video data captured by the camera.

Looking to FIG. 4A first, there is a volume peak of a dominant sound source 23 at an angle corresponding to the spatial location of the first person 30a in the FOV 7. Corresponding directional data 20 denotes the angle of the dominant sound source 23. Looking now to FIG. 4B, there is a new volume peak of a dominant sound source 23′ at an angle corresponding to the spatial location of the second person 30a in the FOV 7. Again, corresponding directional data 20′ denotes the angle of the dominant sound source 23′.

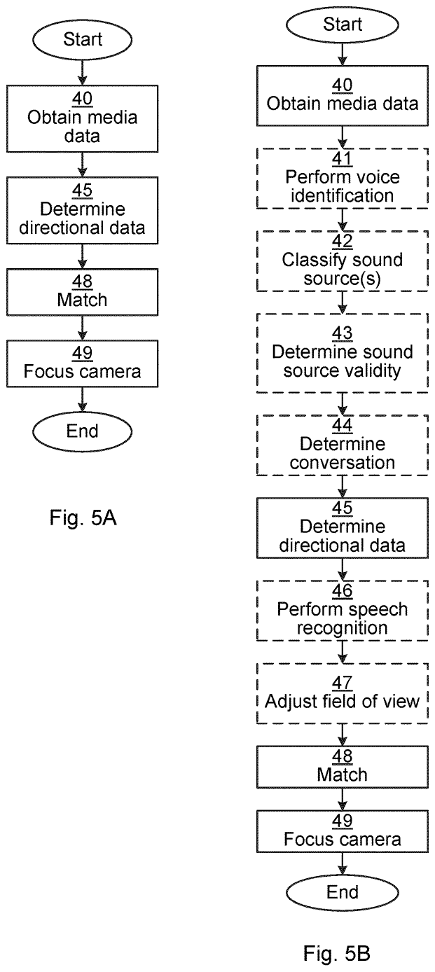

FIGS. 5A and 5B are flow charts illustrating embodiments of methods for focusing a camera 10 capturing video data 15. The method is performed in a focus determiner 1. The camera 10 and at least one microphone 11a, 11b, for capturing the audio data, can be mounted in a fixed relation to each other, simplifying the determination of direction to sound sources and matching such sources against objects in images captured by the camera.

In an obtain media data step 40, the focus determiner 1 obtains audio data and video data comprising a plurality of sequential images, wherein the audio data and video data overlap in time and cover the same scene. The same scene here implies that sound emitting objects captured in the video data result in sound that is also captured in the audio data.

In a determine directional data step 45, the focus determiner 1 determines directional data 20, 20′ of a dominant sound source 23, 23′ in the audio data. The directional data can be determined by determining a direction of the dominant sound source 23, 23′ based on multiple sound channels in the audio data.

In a match step 48, the focus determiner 1 matches a visual feature spatially, in an image of the plurality of sequential images of the video data, with the directional data 20, 20′, wherein the image corresponds to the directional data in time.

The matching of a visual feature can comprise classifying a plurality of objects in the image being potential sound sources, and determining the visual feature to be the one of the plurality of objects that is located in a position that best matches the directional data 20, 20′. The plurality of objects can be faces.

A more detailed example will now be presented, illustrating how the matching can occur. Two tables are created, one for audio sources and one for objects of the current image from the video data.

The following Table 1 illustrates how the audio data is structured in a source list according to one embodiment:

TABLE 1
Source list based on audio data

| Source | Direction | Name (if | | Content | Sound |
|---|---|---|---|---|---|
| ID | (azi; alt) | identified) | Distance | classification | volume |
| 0 | (−48°, 2°) | FaceID#2 | 3.5 m | Voice | 68 |
| 1 | (−55°, [empty]) | Unknown | 6.0 m | Cat meow | 45 |

The first column comprises an identifier of an audio source. The second column comprises a direction in one direction (azimuth), corresponding to the angle θ in FIGS. 4A and 4B, explained above. Optionally, there are angles in two directions (azimuth and altitude). The third column comprises an optional identity of the source of the sound (see step 41 below), when available. The fourth column comprises an optional indication of distance to the sound source. The fifth column comprises an optional classification of the sound source, e.g. voice, cat meow, dog bark, car engine, etc. The sixth column comprises a sound volume of the source, in suitable unit of measurement, e.g. decibel (dB), etc.

The analysis of the audio data is performed on audio data corresponding to the last presented frame, leading up to the timestamp of the analysed frame, or can include a longer time window to make voice identification and speech recognition more robust.

The previous frame's (or frames') source list can also be used as a prior to guide the image-based source identification procedure.

The following Table 2 illustrates how the image data is structured in an object list according to one embodiment:

TABLE 1
Object list based on image data

| | | | | | Possible |
|---|---|---|---|---|---|
| Object | | | | | audio |
| ID | Class | Dist. | Position | Direction | source? |
| Face 1 | FaceID#1 | 2.0 m | (0, 0), | −80° | Yes |
| | (from social | | (150, 300) | | |
| | contacts) | | | | |
| Face 2 | Unknown #1 | 4.0 m | (10, 400), | −60° | Yes |
| | | | (150, 800) | | |
| Face 3 | FaceID#2 | 3.0 m | (150, 300), | −45° | Yes |
| | | | (700, 700) | | |
| Object 1 | Cat | 2.2 m | (0, 20), | −80° | Yes |
| | | | (50, 80) | | |
| Object 2 | Stone | 4.0 m | | | No |

The first column comprises an object identifier. The second column comprises a classification of the object. The optional third column comprises a distance to the object. The fourth column comprises position data. The position data can be a centre position of the object in coordinates, or coordinates specifying minimal geometric figure enclosing the object, e.g. a bounding box or bounding circle. In the example of Table 1, the fourth column specifies opposite corners of a bounding box enclosing the object. However, it is to be noted that position can be represented in any other format that identifies the position of the object. The position can be in the form of a centre point of the object or in the form of a bounding box encompassing the object. The fifth column comprises a direction, which can be derived as a direction to the centre point of the object within the FOV. The sixth column comprises an indication whether the object is a potential audio source. This can be derived from the class of the object. For instance, in the example of Table 2, only the stone is not a possible audio source, and can thus be ignored from the matching.

The objects and sound sources are then matched, based on direction. Each sound source that is mapped against an object, then results in that the object is a potential focus point for the camera.

In a focus camera step 49, the focus determiner 1 focuses a camera 10, being the source of the video data, to focus on the visual feature for subsequent capturing of video data.

The focusing can be combined with other focusing procedures, such as the focus determined above being overridden by a manual indication of where to focus, e.g. by the user tapping directly on a touch screen (of a smartphone capturing video).

The method can be is repeated periodically with a time period corresponding to a preconfigured number of frames of the video data.

Looking now to FIG. 5B, only steps that are new or modified compared to FIG. 5A will be described.

In one embodiment, the camera 10 is provided in the user device 2, in which case the method comprises a perform voice identification step 41, in which the focus determiner 1 performs voice identification on the audio data, wherein the voice identification results in a match with a person 30a, 30b. For instance, the voice can be identified to belong to a person that is associated with the user (e.g. in a contact list, social media contacts, etc.). This can be used to increase priority for that person. Consider a situation of a crowd of people, where a person that is a friend of the user 5 filming speaks up. In this case, the matching makes it more likely to match the sound of that person.

When voice identification is performed, the directional data can be determined (in the determine directional data step 45) by determining a direction of the dominant sound source 23, 23′ based on excluding (as a potential dominant sound source) a sound source matching directional data of the person, when the voice data of the person is a matched with the voice data of the user 5 of the user device 2. In other words, the voice of the user can be stored, to allow any sound containing user voice from being ignored for focusing purposes.

In this embodiment, the match step 48 comprises increasing a matching priority for a sound source matching directional data of the person 30a, 30b′, when the person is associated with the user 5 of the user device 2, but fails to be the user 5. In other words, if the sound matches the voice of the user, this should not affect the matching.

In an optional classify sound source(s) step 42, the focus determiner 1 classifies a plurality of sound sources in the audio data, e.g. as reflected in the fifth column of Table 1.

In an optional determine sound source validity step 43, the focus determiner 1 determines, for each classified sound source, whether the sound source is to be matched with a visual feature. In this embodiment, the determine directional data step 45 comprises excluding, as a potential dominant sound source, any one or more sound sources that are determined not to be matched with a visual feature, e.g. the stone 32 of FIG. 1.

In an optional determine conversation step 44, the focus determiner 1 determines that a conversation occurs between a plurality of people associated with the faces, e.g. as in the situation illustrated by FIGS. 3A-B and FIGS. 4A-B, described above. In this embodiment, the match step 48 comprises increasing a matching priority for sound sources matching directional data of the plurality of people associated with the faces. This reduces the search space of potential objects to focus on. For instance, when a conversation occurs, dog barks can be ignored as a potential object to focus on. It is to be noted that the conversation determining occurs based on a longer time period than the instant audio/object matching.

In an optional perform speech recognition step 46, the focus determiner 1 performs speech recognition of at least one voice sound source in the audio data, resulting in text data for each one of the at least one voice sound source. In this embodiment, the match step 48 comprises adjusting a matching priority for each one of the at least one voice sound source based on the respective text data.

The speech recognition (based on natural language processing) can also be used to infer a role between the subject and the photographer.

For instance, when a subject mentions “Dad look here”, this implies a (child-father) relationship between the subject and photographer. This can then result in a higher priority for the subject.

In an optional adjust field of view step 47, the focus determiner 1 adjusts a field of view such that the video data covers the dominant directional data 20, 20′ of the dominant sound source 23, 23′.

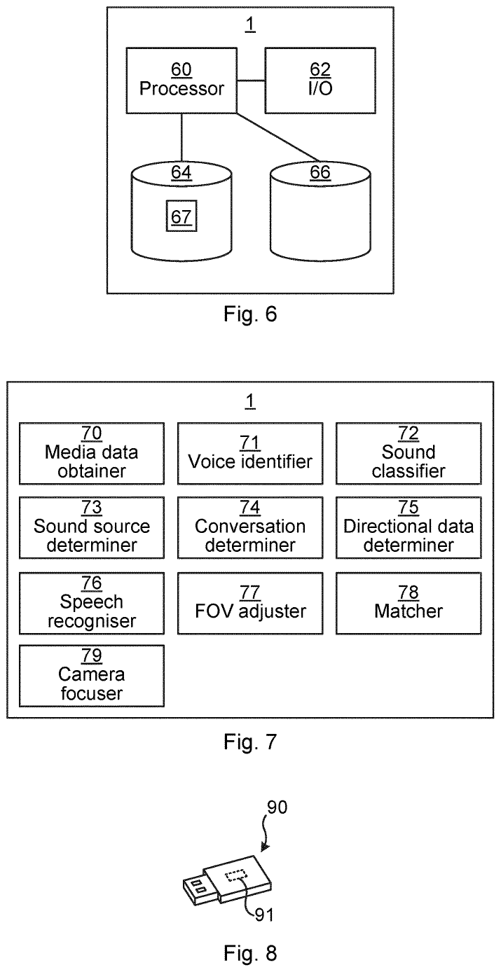

FIG. 6 is a schematic diagram illustrating components of the focus determiner 1 of FIGS. 2A and 2B according to one embodiment. It is to be noted that when the focus determiner 1 is implemented in a host device, one or more of the mentioned components can be shared with the host device. A processor 60 is provided using any combination of one or more of a suitable central processing unit (CPU), graphics processing unit (GPU), multiprocessor, neural processing unit (NPU), microcontroller, digital signal processor (DSP), etc., capable of executing software instructions 67 stored in a memory 64, which can thus be a computer program product. The processor 60 could alternatively be implemented using an application specific integrated circuit (ASIC), field programmable gate array (FPGA), etc. The processor 60 can be configured to execute embodiments of the methods described with reference to FIGS. 5A and 5B above.

The memory 64 can be any combination of random-access memory (RAM) and/or read-only memory (ROM). The memory 64 also comprises non-transitory persistent storage, which, for example, can be any single one or combination of magnetic memory, optical memory, solid-state memory or even remotely mounted memory.

A data memory 66 is also provided for reading and/or storing data during execution of software instructions in the processor 60. The data memory 66 can be any combination of RAM and/or ROM.

An I/O interface 62 is provided for communicating with external and/or internal entities using wired communication, e.g. based on Ethernet, and/or wireless communication, e.g. Wi-Fi, and/or a cellular network, complying with any one or a combination of sixth generation (6G) mobile networks, next generation mobile networks (fifth generation, 5G), LTE (Long Term Evolution), UMTS (Universal Mobile Telecommunications System) utilising W-CDMA (Wideband Code Division Multiplex), or any other current or future wireless network, as long as the principles described hereinafter are applicable.

Other components of the focus determiner 1 are omitted in order not to obscure the concepts presented herein.

FIG. 7 is a schematic diagram showing functional modules of the focus determiner 1 of FIG. 6 according to one embodiment. The modules are implemented using software instructions such as a computer program executing in the focus determiner 1. Alternatively or additionally, the modules are implemented using hardware, such as any one or more of an ASIC (Application Specific Integrated Circuit), an FPGA (Field Programmable Gate Array), or discrete logical circuits. The modules correspond to the steps in the methods illustrated in FIGS. 5A-B.

A media data obtainer 70 corresponds to step 40. A voice identifier 71 corresponds to step 41. A sound classifier 72 corresponds to step 42. A sound source determiner 73 corresponds to step 43. A conversation determiner 74 corresponds to step 44. A directional data determiner 75 corresponds to step 45. A speech recogniser 76 corresponds to step 46. A FOV (field of view) adjuster 77 corresponds to step 47. A matcher 78 corresponds to step 48. A camera focuser 79 corresponds to step 49.

FIG. 8 shows one example of a computer program product 90 comprising computer readable means. On this computer readable means, a computer program 91 can be stored in a non-transitory memory. The computer program can cause a processor to execute a method according to embodiments described herein. In this example, the computer program product is in the form of a removable solid-state memory, e.g. a Universal Serial Bus (USB) drive. As explained above, the computer program product could also be embodied in a memory of a device, such as the computer program product 64 of FIG. 6. While the computer program 91 is here schematically shown as a section of the removable solid-state memory, the computer program can be stored in any way which is suitable for the computer program product, such as another type of removable solid-state memory, or an optical disc, such as a CD (compact disc), a DVD (digital versatile disc) or a Blu-Ray disc.

The aspects of the present disclosure have mainly been described above with reference to a few embodiments. However, as is readily appreciated by a person skilled in the art, other embodiments than the ones disclosed above are equally possible within the scope of the invention, as defined by the appended patent claims. Thus, while various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

1. A method for focusing a camera capturing video data, the method being performed in a focus determiner, the method comprising:
obtaining audio data and video data, comprising a plurality of sequential images, wherein the audio data and video data overlap in time and cover the same scene;
determining directional data of a dominant sound source in the audio data;
matching a visual feature spatially, in an image of the plurality of sequential images of the video data, with the directional data, wherein the image corresponds to the directional data in time; and
focusing a camera, being the source of the video data, to focus on the visual feature for subsequent capturing of video data.

2. The method according to claim 1, wherein the determining directional data comprises determining a direction of the dominant sound source based on multiple sound channels in the audio data.

3. The method according to claim 1, wherein the matching a visual feature comprises classifying a plurality of objects in the image being potential sound sources, and determining the visual feature to be the one of the plurality of objects that is located in a position that best matches the directional data.

4. The method according to claim 3, wherein the plurality of objects are faces.

5. The method according to claim 4, further comprising:
determining that a conversation occurs between a plurality of people associated with the faces, and
wherein the matching a visual feature comprises increasing a matching priority for sound sources matching directional data of the plurality of people associated with the faces.

6. The method according to claim 1, further comprising:
adjusting a field of view such that the video data covers the dominant directional data of the dominant sound source.

7. The method according to claim 1, wherein the method is repeated periodically with a time period corresponding to a preconfigured number of frames of the video data.

8. The method according to claim 1, wherein the camera is provided in a user device, and wherein the method further comprises:
performing voice identification on the audio data, wherein the voice identification results in a match with a person; and
wherein the matching a visual features comprises increasing a matching priority for a sound source matching directional data of the person, when the person is associated with the user of the user device, but fails to be the user.

9. The method according to claim 8, wherein the determining directional data of a dominant sound source comprises excluding, as a potential dominant sound source, a sound source matching directional data of the person, when the voice data of the person is a matched with voice data of the user of the user device.

10. (canceled)

11. The method according to claim 1,
further comprising:
performing speech recognition of at least one voice sound source in the audio data, resulting in text data for each one of the at least one voice sound source;
wherein the matching a visual feature comprises adjusting a matching priority for each one of the at least one voice sound source based on the respective text data.

12. (canceled)

13. A focus determiner for focusing a camera capturing video data, the focus determiner comprising:
a processor; and
a memory storing instructions that, when executed by the processor, cause the focus determiner to:
obtain audio data and video data, comprising a plurality of sequential images, wherein the audio data and video data overlap in time and cover the same scene;
determine directional data of a dominant sound source in the audio data;
match a visual feature spatially, in an image of the plurality of sequential images of the video data, with the directional data, wherein the image corresponds to the directional data in time; and
focus a camera, being the source of the video data, to focus on the visual feature for subsequent capturing of video data.

14. The focus determiner according to claim 13, wherein the instructions to determine directional data comprise instructions that, when executed by the processor, cause the focus determiner to determine a direction of the dominant sound source based on multiple sound channels in the audio data.

15. The focus determiner according to claim 13, wherein the instructions to match a visual feature comprise instructions that, when executed by the processor, cause the focus determiner to classify a plurality of objects in the image being potential sound sources, and determine the visual feature to be the one of the plurality of objects that is located in a position that best matches the directional data.

16. The focus determiner according to claim 15, wherein the plurality of objects are faces.

17. The focus determiner according to claim 16, further comprising instructions that, when executed by the processor, cause the focus determiner to:
determine that a conversation occurs between a plurality of people associated with the faces, and
wherein the instructions to match a visual feature comprise instructions that, when executed by the processor, cause the focus determiner to increase a matching priority for sound sources matching directional data of the plurality of people associated with the faces.

18. The focus determiner according to claim 13, further comprising instructions that, when executed by the processor, cause the focus determiner to adjust a field of view such that the video data covers the dominant directional data of the dominant sound source.

19. The focus determiner according to claim 13, wherein the instructions are repeated periodically with a time period corresponding to a preconfigured number of frames of the video data.

20. The focus determiner according to claim 13, wherein the camera is provided in a user device, and wherein the focus determiner further comprises instructions that, when executed by the processor, cause the focus determiner to perform voice identification on the audio data, wherein the voice identification results in a match with a person; and wherein the instructions to match a visual features comprise instructions that, when executed by the processor, cause the focus determiner to increasing a matching priority for a sound source matching directional data of the person, when the person is associated with the user of the user device, but fails to be the user.

21-23. (canceled)

24. The focus determiner according to claim 13, wherein the camera and at least one microphone, for capturing the audio data, are mounted in a fixed relation to each other.

25. A computer program for focusing a camera capturing video data, the computer program comprising computer program code which, when executed on a focus determiner causes the focus determiner to:
obtain audio data and video data, comprising a plurality of sequential images, wherein the audio data and video data overlap in time and cover the same scene;
determine directional data of a dominant sound source in the audio data;
match a visual feature spatially, in an image of the plurality of sequential images of the video data, with the directional data, wherein the image corresponds to the directional data in time; and
focus a camera, being the source of the video data, to focus on the visual feature for subsequent capturing of video data.

26. (canceled)
